(19) United States
(12) Patent Application Publication
(10) Pub. No.: US 2002/0133530 A1
(43) Pub. Date: Sep. 19, 2002

(54) Method for resource control including resource stealing

(76) Inventor: Maarten Koning, Bloomfield (CA)

Correspondence Address: KENYON & KENYON, ONE BROADWAY, NEW YORK, NY, 10004, US

(21) Appl. No.: 09/808,899

(22) Filed: Mar. 15, 2001

(51) Int. Cl. G06F 9/00

(52) U.S. Cl. 709/102

(57) ABSTRACT

A method for resource control including resource stealing is disclosed, the method including assigning a resource to a holding task, receiving a request by a higher priority task to take the resource, the higher priority task having higher priority than the holding task, determining whether the holding task has used the resource since the resource was assigned to the holding task, releasing the resource when the higher priority task requests to take the resource and the holding task has not used the resource since the resource was assigned to the holding task; and assigning the resource to the higher priority task.

A portion of the disclosure of this patent document contains material which is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND INFORMATION

Traditional multitasking operating systems (e.g., UNIX, Windows) have been implemented in computing environments to provide a way to allocate the resources of the computing environment (e.g., CPU, memory, Input/Output (I/O) devices) among various user applications that may be running simultaneously in the computing environment. The operating system itself includes a number of functions (executable code) and data structures that may be used to implement the resource allocation services of the operating system. A program that performs actions may be referred to as a task (also known as a “thread”), and a collection of tasks may be referred to as a “process”. Upon loading and execution of the operating system into the computing environment, “system tasks” and “system processes” are created in order to support the resource allocation needs of the system. User applications likewise, upon execution, may cause the creation of tasks (“user tasks”) and processes (“user processes”) in order to perform the actions desired from the application.

Systems may often include shared resources that when accessed by a first task, should not be subsequently accessed by a second task until the first task's use of the resource has been completed. Examples of such shared resources may include a tape, a table in a database, a critical region in memory, etc. Operating systems may include one or more mutual exclusion control mechanisms, e.g., disabling interrupts, preemptive locks, or mutual exclusion semaphores, that may be used to prevent a second task's access to such shared resources while the resources are in use by a first task.

Operating systems also may include a priority control mechanism to control the execution of both system and user tasks. In a priority control mechanism, tasks may be assigned a priority value, e.g., a number ranging from a lowest priority to a highest priority. When multiple tasks contend for resources, a higher priority task generally receives more resources from the system than a lower priority task. A system including a priority control mechanism generally will not force a higher priority task to wait for a lower priority task to complete, but instead, where possible, may preempt the lower priority task until the high priority task either terminates, has its priority lowered, or stops for some other reason.

Some systems include so-called “absolute” priority control mechanisms. In an “absolute” priority control mechanism, lower priority tasks never preempt higher priority tasks. A higher priority task generally receives all available system resources until it completes, or until an even higher priority task interrupts the task. However, altering the control of a critical shared resource in the middle of the lower priority task's use of the resource may jeopardize the integrity of the resource. For example, if the lower priority task is currently writing to a table in a database, allowing another higher priority task to write while the lower priority task's write operation is in progress may damage the integrity or consistency of the table. Therefore, mutual exclusion control mechanisms may be configured to allow a lower priority task to maintain control of a critical shared resources even when the lower priority task is preempted by a higher priority task.

FIG. 1 illustrates a problem that may occur in a conventional system that includes a mutual exclusion control mechanism and a priority control mechanism. A lower priority task, task B, may be executing, as shown at point 102. At point 104, task B requests a resource currently held by another, higher priority task, task A. The resource is protected by a mutual exclusion control mechanism, i.e., the resource cannot normally be taken from a task that is using it, irrespective of the task's priority. (Note that, even in a system with an absolute priority control mechanism, task B might be executing while the higher priority task A waits, because task A is waiting for another, different resource.) Because the resource needed by task B is currently held by Task A, task B blocks, and waits for the resource. At some later time 106, the higher priority task A resumes executing. At time 108, task A finishes using the resource that was requested by task B. Task A releases the resource, and may give it to task B, depending on how resource control mechanisms are implemented in the system. For example, if the resource was controlled by a mutual exclusion semaphore, task A might give the semaphore to task B. Task B is denoted here with a circle, rather than a rectangle to indicate that Task B does not actually execute at time 108. Instead, the resource is simply assigned to Task B during Task A's execution. After giving the resource to task B, task A resumes executing until time 110. At 110, task A requests the resource. However, the resource is now held by task B, so task A blocks on the resource. Task B may begin executing, and continue executing until 112. At 112, task B finishes with the resource and returns the resource to task A, allowing task A to unblock and continue execution.

### SUMMARY

In accordance with an example embodiment of the present invention, a method may be provided that includes assigning a resource to a holding task, receiving a request by a higher priority task to take the resource, the higher priority task having higher priority than the holding task, determining whether the holding task has used the resource since the resource was assigned to the holding task, releasing the resource when the higher priority task requests to take the resource and the holding task has not used the resource since the resource was assigned to the holding task, and assigning the resource to the higher priority task.

In accordance with an example embodiment of the present invention, a method may be provided that includes assigning a semaphore to a holding task, the semaphore being a mutual exclusion semaphore, receiving a request by a higher priority task to take the semaphore, the higher priority task having higher priority than the holding task, determining whether the holding task has executed since the semaphore was assigned to the holding task, releasing the semaphore held by the holding task when the higher priority task requests to take the semaphore and the holding task has not executed since the semaphore was assigned to the holding task; and assigning the semaphore to the higher priority task.

In accordance with an example embodiment of the present invention, an article of manufacture may be provided, the article of manufacture including a computer-readable medium having stored thereon instructions adapted to be executed by a processor, the instructions which, when executed, define a series of steps to be used to control a method for resource control, the steps including assigning a resource to a holding task, receiving a request by a higher priority task to take the resource, the higher priority task having higher priority than the holding task, determining whether the holding task has used the resource since the resource was assigned to the holding task, releasing the resource when the higher priority task requests to take the resource and the holding task has not used the resource since the resource was assigned to the holding task, and assigning the resource to the higher priority task.

In accordance with an example embodiment of the present invention, an article of manufacture may be provided, the article of manufacture including a computer-readable medium having stored thereon instructions adapted to be executed by a processor, the instructions which, when executed, define a series of steps to be used to control a method for resource control, the steps including assigning a semaphore to a holding task, the semaphore being a mutual exclusion semaphore, receiving a request by a higher priority task to take the semaphore, the higher priority task having higher priority than the holding task, determining whether the holding task has executed since the semaphore was assigned to the holding task, releasing the semaphore held by the holding task when the higher priority task requests to take the semaphore and the holding task has not executed since the semaphore was assigned to the holding task; and assigning the semaphore to the higher priority task.

In accordance with an example embodiment of the present invention, a system may be provided that includes a semaphore, and a semaphore control mechanism configured to release the semaphore if: a first task holds the semaphore, a second task having higher priority than the first task attempts to take the semaphore, and, when the second task attempts to take the semaphore, the first task has not executed since receiving the semaphore.

### BRIEF DESCRIPTION OF THE DRAWINGS

FIG. 1 illustrates a problem that may occur in conventional implementations of systems that include a mutual exclusion control mechanism and a priority control mechanism.

FIG. 2 illustrates an example use of resource stealing, in an example embodiment implemented according to the present invention.

FIG. 3 illustrates an example procedure for taking a semaphore, in an example embodiment implemented according to the present invention.

FIG. 4 illustrates a continuation of the example procedure for taking a semaphore for a requesting task that has blocked on a semaphore that is held by another task, in an example embodiment according to the present invention

FIG. 5 illustrates an example procedure for giving a semaphore, in an example embodiment implemented according to the present invention.

FIG. 6 illustrates an example computing environment, according to an example embodiment of the present invention.

FIG. 7 illustrates an example memory space in an example computing environment, according to an example embodiment of the present invention.

FIG. 8 illustrates an example operating system queue structure, in an example embodiment implemented according to the present invention.

FIG. 9 illustrates an example task control block data structure, in an example embodiment implemented according to the present invention.

FIG. 10 illustrates an example semaphore control data structure, in an example embodiment implemented according to the present invention.

FIG. 11 illustrates an alternative example task control block data structure, in an alternative example embodiment implemented according to the present invention.

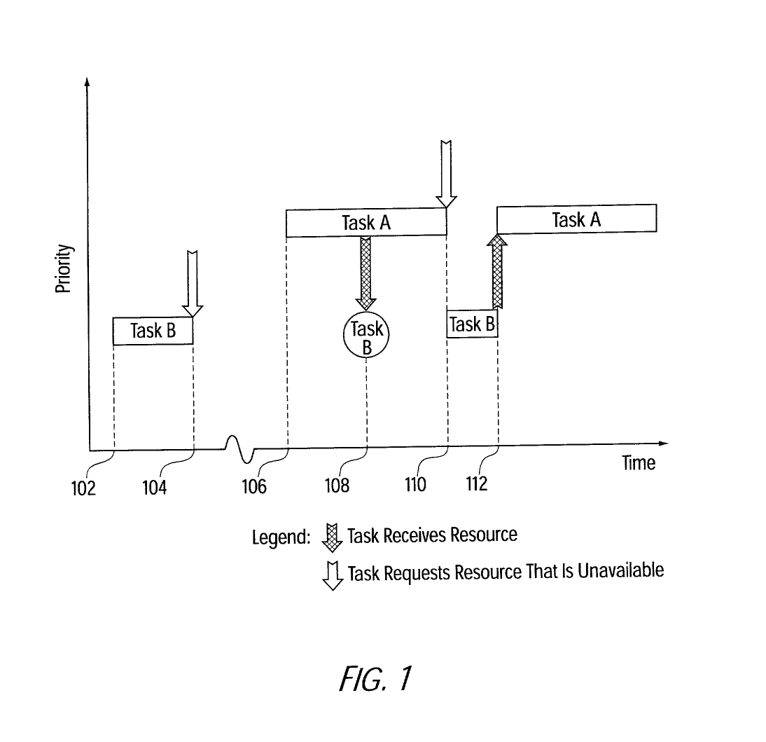

### DETAILED DESCRIPTION

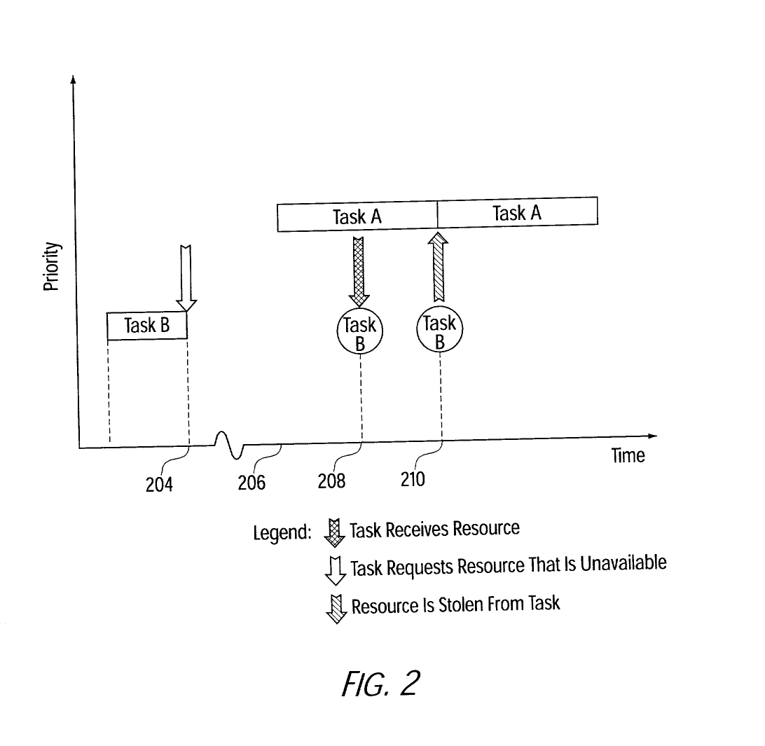

FIG. 2 illustrates an example use of resource stealing, in an example embodiment implemented according to the present invention. The low priority task B blocks on a resource at 204. The resource is held by a higher priority task A. The resource is protected by a mutual exclusion control mechanism (for example, a semaphore), such that the resource cannot normally be taken from a task that is using it, irrespective of the task's priority. At some later time 206, higher priority task A, which holds the resource requested by task B, begins executing. Task A finishes using the resource at 208, and gives the semaphore to Task B. Task B is denoted here with a circle, rather than a rectangle, to indicate that Task B does not actually execute at time 208. Instead, the resource is simply assigned to Task B during Task A's execution. At 210, task A again needs the resource which is now held by task B. However, task B has not used the resource since receiving it from task A. In fact, task B has not executed at all since receiving the resource from task A. Therefore, the resource can be “stolen” from task B and given to task A, without task B executing. Task A receives the resource and may continue to execute without blocking. This resource stealing may improve the real-time performance of higher priority task A, which no longer has to wait to receive the semaphore from task B.

### Example Embodiment

An example embodiment implemented according to the present invention may be included as part of a computer environment, e.g., in a computer operating system. The example embodiment may include a priority control mechanism, a mutual exclusion control mechanism, mechanisms to control priority inheritance, as well as other conventional features of a computer operating system.

The example embodiment implemented according to the present invention may include an absolute priority control mechanism. It will be appreciated that any conventional method of implementing a priority control mechanism may be employed. Each task may have an associated “priority number” indicating the task's current priority. In the discussion below, it is assumed that high priority tasks have a higher priority number than low priority tasks. It will be appreciated that other conventions for indicating relative priority may be used, as long as they are used consistently. For example, a system could be implemented where 0 indicated the highest, rather than the lowest priority, and where higher numbers indicated lower priority.

The example embodiment may include a “scheduler” which determines which task executes at a given time. Tasks that are candidates for execution may have entries included in a system “ready” queue from which the scheduler selects a task for execution. The scheduler may select the highest priority task with an entry in the “ready” queue for execution. When higher priority tasks are “ready”, currently executing lower priority tasks may be preempted and returned to the ready queue. Tasks may have entries stored on the ready queue in priority order, in order to facilitate the operation of the scheduler. Tasks that are blocked, i.e., waiting for resources, may be tracked by an entry in a “wait” queue. When a task receives a resource that it is waiting for, it may have its entry moved from the wait queue to the ready queue. When tasks that are executing block on an unavailable resource, their entry may be placed on the wait queue.

In an example embodiment implemented according to the present invention, several types of semaphores may be included. The example embodiment may include “binary” semaphores that may be used primarily for synchronization. A binary semaphore may be created by invoking a procedure that creates the semaphore. A task may “take” the semaphore using a “take” function provided as part of the operating system. A second task that attempts to take a semaphore that is already taken by a first task may wait, either indefinitely, or for a pre-specified interval, for the first task to “give” or “release” the semaphore. A task may “give” or release” the semaphore by invoking a “give” or “release” function provided as part of the operating system. A semaphore that is given may be assigned to a task that currently is waiting to take it. The example embodiment may also include a “flush” operation for binary semaphores that unblocks all tasks that are waiting for a particular semaphore. The flush function makes binary semaphores generally unsuitable for controlling resources that require strictly mutually exclusive access.

The example embodiment may also include “mutual exclusion semaphores”. Mutual exclusion semaphores may be used to control access to shared resources. Mutual exclusion semaphores in the example embodiment may include several features that make them more suitable than binary semaphores for controlling access to shared resources where mutually exclusive access is desired. In the example embodiment, a mutual exclusion semaphore may generally only be given by the task that took it. Also in the example embodiment, a mutual exclusion semaphore may not be given during an interrupt service routine, a special procedure used to handle hardware interrupts without context switching. Also in the example embodiment, a mutual exclusion semaphore may not be flushed. Mutual exclusion semaphores may also be “inversion safe”, i.e., designed to include a mechanism for priority inheritance that temporarily increase the priority of low priority tasks holding mutual exclusion semaphores that higher priority tasks are waiting for.

When a task wants to access a shared resource that is controlled by a mutual exclusion semaphore, it must first “take” or acquire the semaphore associated with that resource, e.g., by invoking a “take” or request function made available as part of the operating system. As long as the task keeps the semaphore, all other tasks seeking access to the resource are generally blocked from accessing the resource. A task that invokes the “take” procedure for a mutual exclusion semaphore that is held by another task may become “blocked”. The blocked task may wait indefinitely to receive the requested semaphore. Alternatively, the blocked task may wait for a specified “timeout period”, e.g., an interval of time that may be specified in the invocation of the take function.

When the task holding a shared resource controlled by a mutual exclusion semaphore finishes it use of the resource, the task may “give” or “release” the semaphore, e.g., by invoking a “give” or “release” function. When the semaphore is released, another waiting task may take the semaphore, allowing the task that receives the semaphore to use the resource. The give function may assign the resource to a waiting task directly.

It will be appreciated that alternative approaches may be employed, where the give function does not immediately assign the resource to a waiting lower priority task. However, such an approach may require the scheduler or priority control mechanism to identify when the resource should be assigned to the task, e.g., when other higher priority tasks are neither ready to execute nor waiting for the same resource.

However, such an alternative approach may result in a significant overhead in the scheduler or priority control mechanism. Such increased overhead may be acceptable in a system where there is a large amount of semaphore contention.

An example embodiment implemented according to the present invention may include procedures for “resource stealing” for resources protected by mutual exclusion semaphores. These procedures may be included as part of operating system functions used to take and give mutual exclusion semaphores. Resource stealing procedures may also be included as part of the scheduler or other operating system functions that are used to control the execution of tasks, e.g., procedures for starting, waiting or pending tasks, and controlling task queues. It will be appreciated that the resource stealing procedures described for use with mutual exclusion semaphores could readily be adapted for use with other mutual exclusion control mechanisms, or with other types of semaphores.

Example Take Procedure Including Resource Stealing

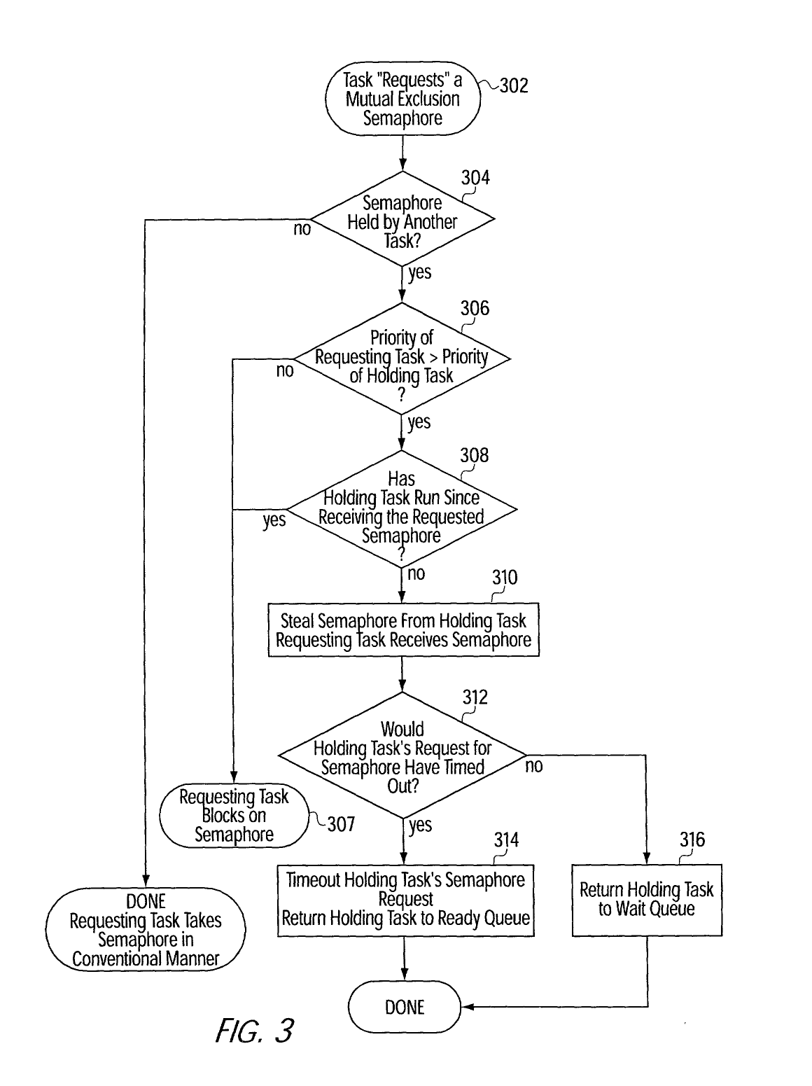

FIG. 3 illustrates an example “take” procedure that incorporates resource stealing, in an example embodiment implemented according to the present invention.

In step 302, a task that is currently executing attempts to take a mutual exclusion semaphore. The task may attempt to take the semaphore by executing an operating system “take” or request function call. A “take” function call may include an identifier for the semaphore requested and a timeout limit, e.g., an amount of time the task will wait before “timing out” and unblocking without receiving the semaphore.

In step 304, whether the requested semaphore is held by another task may be determined. This may be accomplished by checking a variable associated with the semaphore. The variable may be included in a semaphore control data structure that corresponds to the requested semaphore. For example, the semaphore control data structure may contain a field identifying the owning task, with the field set to “NULL” if the semaphore is currently not held by any task. If the semaphore is not held by any task, then the example procedure may be completed by having the requesting take the requested semaphore in a conventional manner. However, if the requested semaphore is currently owned by another task, then the example procedure may proceed to step 306.

In step 306, whether the task currently holding the semaphore has a higher priority than the requesting task may be determined. A higher priority task may be holding the requested semaphore, even though a lower priority task is currently executing, if the higher priority task is currently blocked on a different semaphore. If the task holding the semaphore has a higher priority than the requesting task, then the requesting task may block on the requested semaphore in a conventional manner, e.g., by removing the requesting task from the ready queue and placing an entry for the requesting task on a wait queue for the requested semaphore. The example procedure may then continue with step 307. However, if the requesting task has a higher priority than the task holding the semaphore, then resource stealing may be possible, and the example procedure may continue with step 308.

In step 308, whether the task holding the semaphore has executed since receiving the semaphore may be determined. This determination may be made by testing a variable associated with the task, where the variable indicates whether the task has executed since receiving the semaphore. This determination may also be made by testing a variable associated with the semaphore, where the variable indicates whether the task holding the semaphore has executed since the task received the requested semaphore. If the task holding the requested semaphore has executed since receiving the semaphore, then semaphore stealing may not be possible, and the task holding the requested semaphore may maintain control of the requested semaphore. If the task holding the semaphore has not executed since receiving the requested semaphore then the requesting task may be able to steal the semaphore from the holding task. In that case, the example procedure may continue with step 310.

In step 310, the semaphore is stolen from the task holding it. The semaphore is released without the holding task executing a give function call. The holding task may have an entry added to the wait queue, to indicate that the holding task has blocked on the semaphore. The requesting task receives the semaphore. The semaphore control data structure may be updated to reflect that the requesting task will hold the semaphore. Any other conventional steps that are needed to complete the procedure of the requesting task receiving the requested semaphore may also be completed.

In step 312, whether a timeout may be needed for the holding task may be determined. The holding task's last request that resulted in the holding task receiving the requested semaphore was satisfied when the holding task received the semaphore. However, the semaphore has now been stolen from the holding task. If the last request for the stolen semaphore by the holding task would have timed out had the holding task not actually received the stolen semaphore, the example procedure may continue to step 314. If the holding task would not have timed out, the example procedure may continue with step 316.

In step 314, the holding task's last semaphore request may be timed out. The holding task's take request for the semaphore may return an appropriate time out or exception code that indicates the attempt to take the semaphore failed. The holding task may be returned to the ready queue. The take function may be configured to issue a return code even if the task has not executed since requesting the semaphore.

In step 316, the holding task's original request to take the semaphore may be restored. The holding task may have an entry added to the wait queue. The holding task may wait until either the requested semaphore becomes available, or until the holding task's request for the semaphore times out. It will be appreciated that, depending on how timeouts are handled, the timeout clock may need to be restored for the holding task. However, as will be discussed below, the example embodiment may avoid the need for restoring the timeout clock by leaving the timeout clock undisturbed until the holding task has either timed out, or has executed after receiving the semaphore.

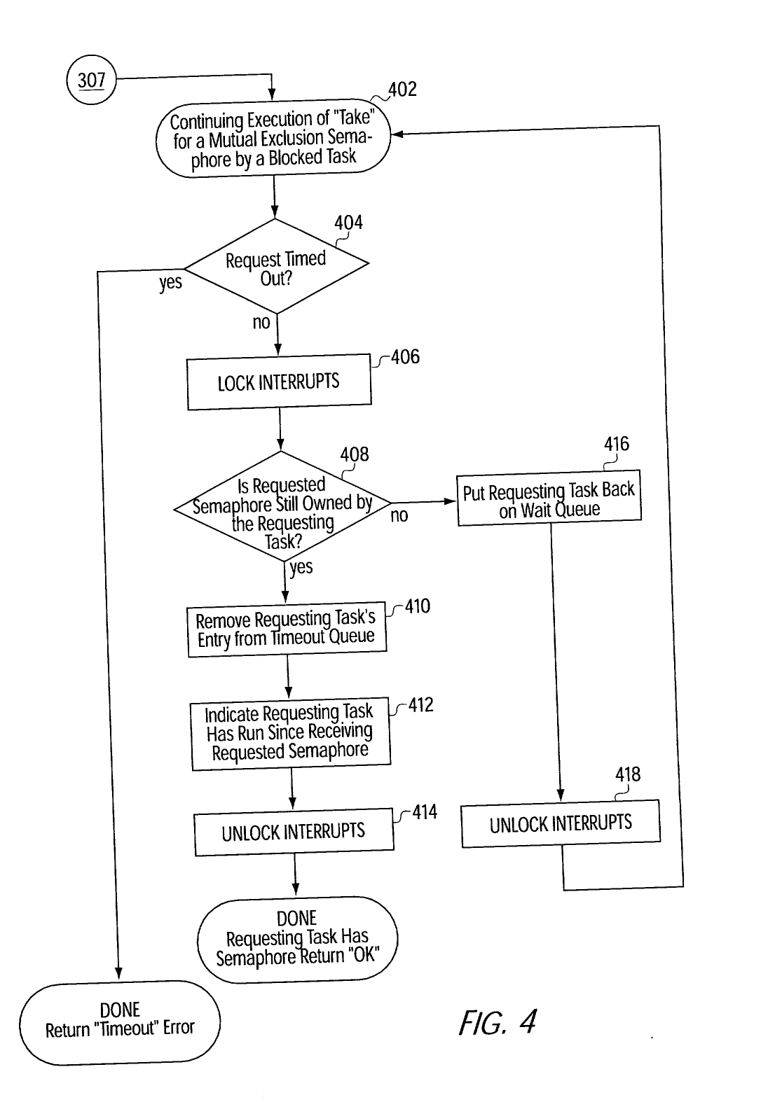

FIG. 4 illustrates additional steps of the example “take” procedure for a requesting task that has initially blocked on a semaphore because the semaphore was held by another task, according to an example embodiment of the present invention. The Figure illustrates steps of the procedure that maybe followed after step 307 of the procedure discussed above and illustrated in FIG. 3.

It will be appreciated that, because the requesting task has blocked on the semaphore, the task may have been placed on a wait queue for the semaphore, and may temporarily stop execution. The task may then wait to resume execution until either it receives the requested semaphore or the task's request for the semaphore times out. In either case, the task would have been moved from the wait queue for the requested semaphore to the ready queue, and would subsequently execute when selected from the ready queue by the scheduler. However, it will also be appreciated that other higher priority tasks may have stolen the requested semaphore from the requesting task while the requesting task was waiting to execute on the system ready queue.

In step 402, the requesting task may begin execution, e.g., when selected to execute by the scheduler. Before this can occur, the task may have either received the requested semaphore, or the semaphore request may have timed out, allowing the task to be moved from the wait queue to the ready queue.

In step 404, the requesting task may be checked to determine whether its semaphore request has timed out. If the request has timed out, the semaphore request may be timed out, e.g., by having the system “take” function return an error code that indicates that the semaphore request has timed out. If the request has not timed out the example take procedure may continue with step 406.

In step 406, the example take procedure may disable interrupts or take other equivalent steps to prevent interruption or preemption. Steps 408-412 and 416 may need to be completed without interruption.

Steps 408-412 and step 416 in the example procedure are surrounded by a dashed box, to indicate that these steps may be performed without interruption or preemption. Although interruption is prevented in the example embodiment by disabling interrupts, any other conventional method of preventing race conditions from arising may be used.

In step 408, the example take procedure may check to determine whether the requesting task still has the requested semaphore, or if, alternatively, the requested semaphore has been stolen by a higher priority task. If the requesting task still has the requested semaphore the procedure may continue with step 410. Otherwise, the example take procedure may continue with step 416.

In step 410, the timeout timer for the requesting task's “take” of the semaphore is turned off, e.g., by removing the requesting task's entry on the timeout queue.

In step 412, an indication is made that the requesting task has run since taking the semaphore, e.g., by setting a “stealable” flag in the semaphore control data structure for the requested semaphore to “FALSE”. This indication may prevent other higher priority tasks from subsequently stealing the semaphore once interrupts are allowed, thereby preventing potential race conditions.

In step 414, interrupts are unlocked, allowing normal execution by the system to resume. The example take procedure may subsequently return an “OK” flag or other indication that the task has successfully acquired the semaphore.

In step 416, the semaphore which the requesting task had acquired has been stolen by a higher priority task before the requesting task has been able to execute. The requesting task may be replaced on the wait queue.

In step 418, interrupts may be unlocked allowing normal execution. Once interrupts are unlocked and the requesting task is returned to the wait queue, the requesting task will block or wait until it receives the semaphore again, or until its request for the semaphore times out. When the task resumes execution, it will continue with step 402.

It will be appreciated that resource stealing may be possible even in situations where the holding task had executed since receiving the semaphore. However, to allow resource stealing where the holding task had executed since receiving the semaphore may require procedures to track whether the resource controlled by the requested semaphore may safely be given to the requesting task, e.g., whether the resource had actually been used the holding task.

It will be appreciated that the steps of the example take procedure, described above, could be defined as a series of instructions adapted to be executed by a processor, and these instruction could be stored on a computer-readable medium, e.g., a tape, a disk, a CD-ROM.

Example Give Procedure Incorporating Resource Stealing

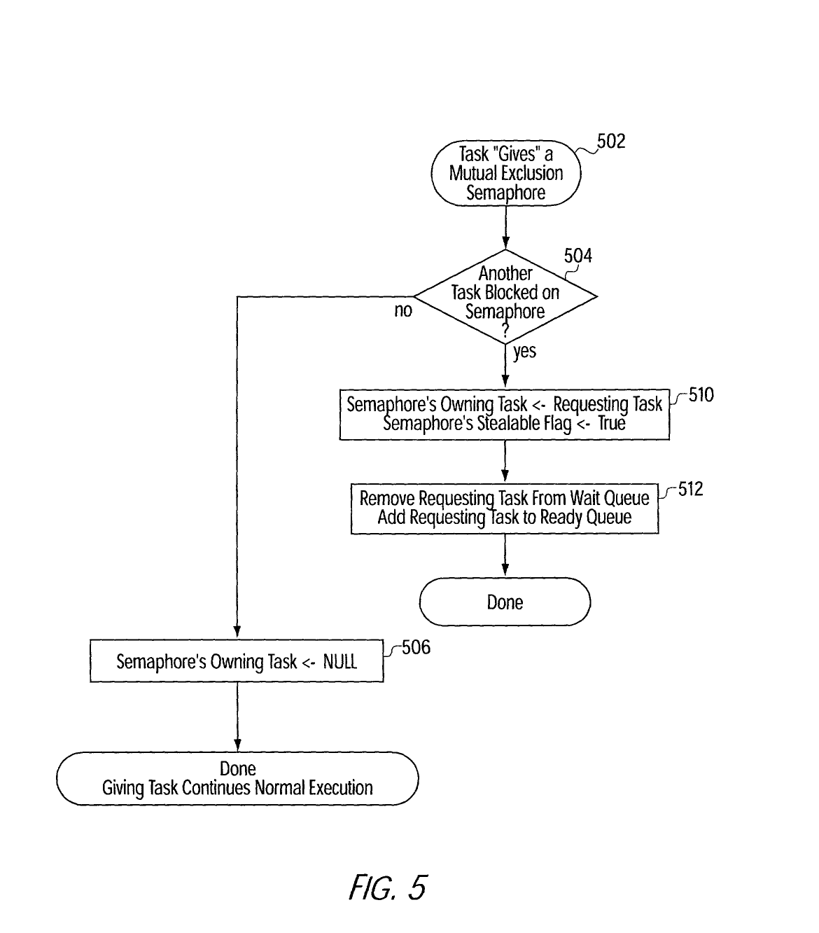

FIG. 5 illustrates an example “give” procedure for mutual exclusion semaphores that has been modified to incorporate resource stealing, in an example embodiment implemented according to the present invention.

In step 502 of the example give procedure, a task finishes using a resource and may release the semaphore that is used to control the resource, for example, by invoking an operating system “give” function. The give function may have arguments which include the identity of the task releasing the resource, and the identity of the semaphore being released.

In step 504 of the example give procedure, if no other task is blocked on the semaphore being released, the example procedure may proceed to step 506. Otherwise, the procedure may proceed to step 510. Whether other tasks are blocked on the semaphore being released may be determined by conventional procedures for controlling tasks and semaphores, e.g., by checking whether there are any entries on the semaphore's wait queue. Alternatively, if a system wait queue is used instead of individual wait queues for individual semaphores, the system wait queue may be checked to determine whether it contains entries corresponding to tasks waiting for the release semaphore.

In step 506 of the example give procedure, no other task is currently waiting for the released semaphore. An indication may be made that no task holds the semaphore, for example, by setting an “owning task variable” associated with the semaphore. This variable may be included in a semaphore control data structure corresponding to the released semaphore. The owning task variable may be set to “NULL” or some other predetermined value that indicates that no task currently holds the semaphore. Indication may be made that the semaphore is stealable by another higher priority task, e.g., by setting a “stealable” flag in the semaphore's semaphore control data structure to “TRUE”. Any other conventional procedures used in releasing a semaphore may also be completed. Once the task has released the semaphore, the task may continue normal execution.

In step 510 of the example give procedure, another task has previously blocked on the semaphore being released. The semaphore may be released from the releasing task and given to the requesting task. An indication may be made that the requesting task now holds the semaphore, for example, by setting an owning task variable in a semaphore control data structure corresponding to the released semaphore. Variables associated with both the task or the semaphore may be set to indicate that the task has executed since receiving the semaphore. For example, a “stealable” flag in the released semaphore's semaphore control data structure may be set to indicate that the task receiving the semaphore has not executed since receiving the semaphore.

In step 512 of the example give procedure, the semaphore is taken from the releasing task and given to a lower priority requesting task. The requesting task will no longer be blocked on the semaphore it has received. An entry for the requesting task in a “wait” queue for the semaphore may be deleted. A corresponding entry in the system “ready” queue may be added. An indication may be made that the semaphore is “stealable”, e.g., by setting a flag in the semaphore's semaphore control data structure.

It will be appreciated that the example embodiment may defer resetting the timeout timer for the receiving task when the receiving task receives the semaphore. The timeout timer in the example embodiment may be reset when the receiving task executes after receiving the semaphore. It will be appreciated that waiting until a task actually executes to reset the timeout timer avoids the problem of having to restore the timeout timer when a semaphore is stolen. However, it will also be appreciated that, alternatively, the timeout timer could be reset when the receiving task receives the requested semaphore, but that resetting the timer would require restoring the timer if a semaphore is stolen.

When step 512 has been completed, the procedure for releasing the semaphore has been completed, and the requesting task has received the semaphore. Once the procedure has been completed, if the receiving task has higher priority than the releasing task, the receiving task may preempt the task that has given the semaphore.

It will be appreciated that the steps of the example give procedure, described above, could be defined as a series of instructions adapted to be executed by a processor, and these instruction could be stored on a computer-readable medium, e.g., a tape, a disk, a CD-ROM.

Example Computing Environment

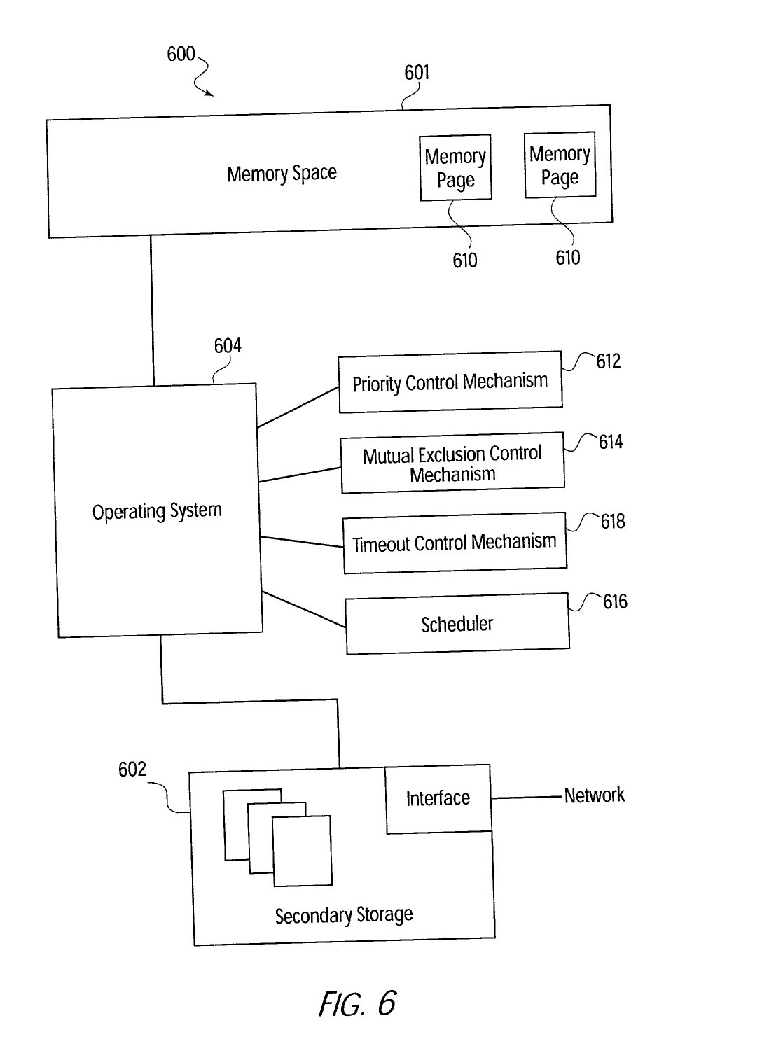

FIG. 6 illustrates an example computing environment 600, according to an example embodiment of the present invention.

A memory space 601 may be provided as part of the computing environment. The memory space 601 may be addressed in any conventional manner, and may be divided into a plurality of memory pages 610.

A secondary storage system 602 may also be provided as part of the computing environment. The secondary storage system may include, disks, tapes, cd-roms, and other storage media. The secondary storage system may also include interfaces to networks that connect the example computing environment to storage systems located on other computer systems.

An operating system 604 may be included as part of the example computing environment.

The operating system may include a priority control mechanism 612. The priority control mechanism may include functions for controlling the execution of tasks of different priorities.

The operating system may also include a mutual exclusion control mechanism 614. The mutual exclusion control mechanism may be used to control access to resources that require mutually exclusive access by tasks, e.g., portions of the memory space 601, and resources in the secondary storage system 602. The mutual exclusion control mechanism 614 may include functions to create, manage, and track mutual exclusion semaphores. The mutual exclusion control mechanism may also include functions allowing tasks to take and release mutual exclusion semaphores. It will be appreciated that the mutual exclusion control mechanism 614 may be provided as a separate set of system functions, or may integrated in other functions in the computing environment.

The operating system may also include a scheduler 616. The scheduler 616 determines which tasks execute and for how long. The scheduler 616 may select a task from a system “ready” queue for execution. The scheduler 616 may also interact with the priority control mechanism, e.g., in determining when executing task may be preempted by higher priority tasks. A preempted task that is still ready to run may be returned to the ready queue, and later selected by the scheduler for further execution.

The operating system may also include a timeout control mechanism 618. The timeout control mechanism 618 may be used to provide real-time timers for use in controlling tasks. For example, timers may provided to allow tasks to wait for an unavailable semaphore for a fixed time period, specified by the task when the take function for semaphores is invoked. The timeout control mechanism 618 tracks timeout timers and signals tasks when timeouts have occurred.

In the example embodiment, each timeout event may have an entry stored on a system timeout queue or event queue. The entries on the timeout queue are stored in real time order, i.e., the soonest events are stored at the head of the timeout queue. At regular intervals or “tics”, a hardware interrupt may be used to trigger the execution of the timeout control mechanism. The timeout control mechanism may check the timeout queue and identify all timeouts that have occurred in the last tic. The timeout control mechanism 618 may signal the corresponding waiting task that a timeout has occurred, and move entries from the wait queue to the system ready queue, so that the timed out tasks may execute.

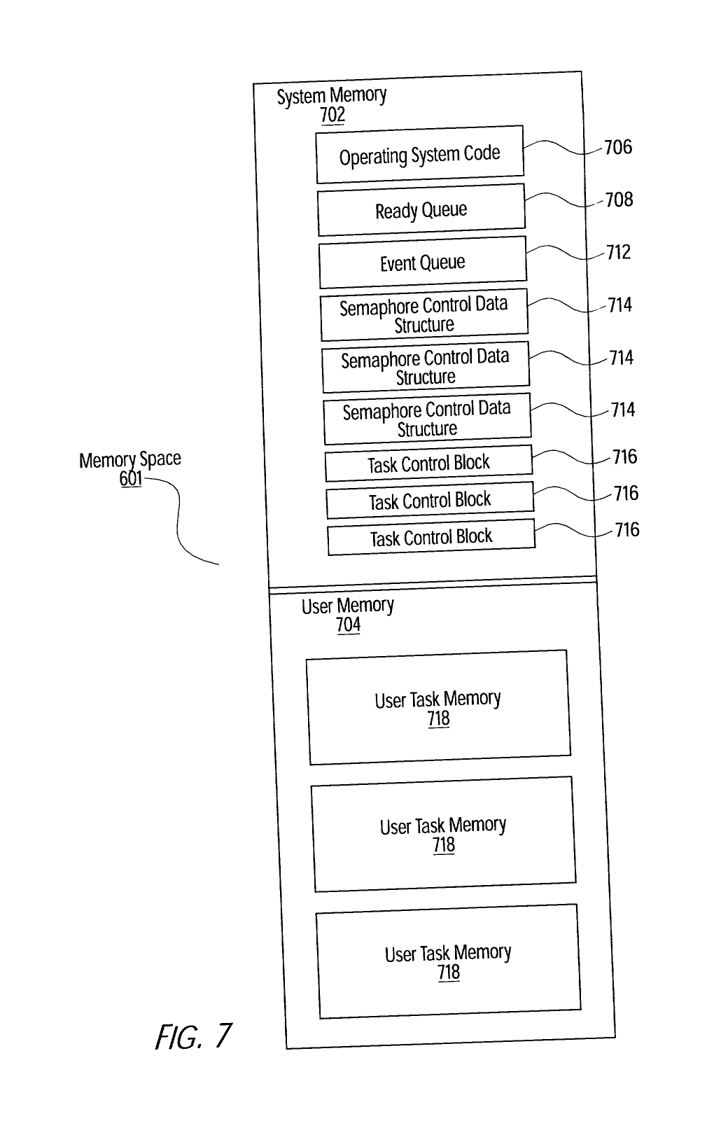

FIG. 7 illustrates an example memory space 601, according to an example embodiment of the present invention. The memory space may be divided into a system memory space 702, generally accessible only by the operating system, and a user memory space 704 that may be accessed by user tasks. The system memory space may include memory space for the operating system executable code 706. The system memory space may include space for operating system queues, including a ready queue 708 and an event or timeout queue 712. It may be convenient to store the space required for these queues contiguously in the system memory space. However, it will be appreciated that conventional methods of tracking entries in the queues may be used that do not require a separate contiguous storage space for each queue, e.g., a linked list may be formed of objects or table entries corresponding to tasks that have entries in a particular queue. Thus the separate structure for the queues in the system memory may only be pointers and other configuration data, the actual contents of the queue may be stored as part of other structures in the system memory.

The system memory space may also include storage space for semaphore control data structures 714 and storage for task control blocks 716. These structure may be included as part of linked lists defining the system ready and timeout queues.

It will be appreciated that no system wait queue is shown in FIG. 7, although one may be provided. In the example embodiment, wait queues may be provided for individual semaphores, rather than as a central structure. The semaphore control data structure 714 may also include (or include links to) a wait queue for the corresponding semaphore.

The user memory space 704 may include user task memory allocations 718 divided into smaller subsets allocated to particular user tasks. Each task memory allocation 718 may include a code space for executable code for the task, as well as a data space to be used as workspace by the task when the task executes.

Operating System Queue Structure

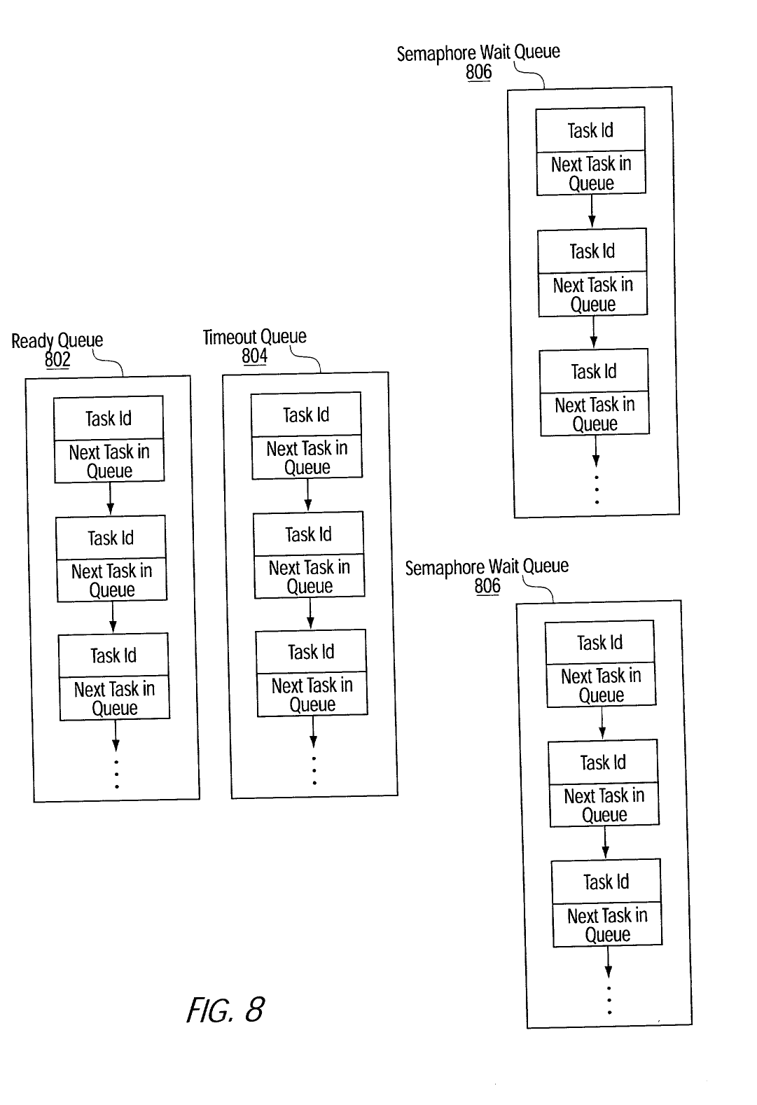

FIG. 8 illustrates an example operating system queue structure, in an example embodiment implemented according to the present invention.

The example operating system queue structure may include a ready queue 802. The ready queue may contain an entry for each task that is currently ready to be executed, i.e., the task is not currently waiting to receive a resource or take a semaphore. Tasks' entries may be stored in the ready queue in decreasing priority order, i.e., the entry at the head of the ready queue may correspond to the highest priority task currently ready to execute. In the example embodiment the entries in the ready queue are the task control blocks, and the pointers are pointers to task control blocks, i.e., the queue is a linked list of task control blocks. It will be appreciated that separate entries could be used, rather than using the task control blocks. Although not shown, it will be appreciated that the ready queue may be maintained as a doubly-linked list in order to allow more efficient management of the ready queue. It will also be appreciated that different data structures may be used to implement a ready queue 802, e.g., a singly list link, a more complex multi-linked list, a priority queue, etc.

The example embodiment may include an example timeout or event queue 804. The example timeout queue may include an entry for each task presently waiting for a resource, where the task has specified a timeout interval, i.e., how long the task will wait for the resource before the resource request times out. The entries on the timeout queue may be stored in real time order, the soonest events first. Each entry may include a field specifying when the corresponding task will time out. Like the ready queue, the entries on the ready queue may be the task control blocks for the waiting tasks, i.e. the timeout queue may be formed as a linked list of task control blocks.

The example embodiment may include separate wait queues 806 for each resource for which tasks can wait. Each wait queue may include entries identifying each task currently waiting for a resource, e.g., waiting to take a semaphore. It will be appreciated that alternative queue structures may be used. For example a central queue might be used to store all tasks currently waiting for resources.

An operating system may include one or more functions for managing the example operating system queue structure. For example, a “scheduler” may be used to control the execution of tasks in the system. The scheduler determines which tasks run, and for how long. The scheduler may also determine when a higher priority task that is ready to run preempts a currently running lower priority task. In the example embodiment, a conventional task scheduler may be used without modification.

It will be appreciated that when changes are made to task priorities due to priority inheritance that appropriate adjustments will need to be made to the operating system queues, e.g., entries stored in queues in priority order may need to be re-sorted.

Task Control Block Data Structure

An example task control block 901 is illustrated in FIG. 9, in an example embodiment implemented according to the present invention. The example task control block may be included as part of a computer operating system. A task control block may be included for each task in the system. The example task control block 901 may be a pre-defined memory object, if the system is implemented using object-oriented programming techniques.

The example task control block 901 may include a variable 902 indicative of the priority of the task. In the example embodiment, priority variable 902 may be implemented as an integer number from 0 to some pre-determined upper bound (e.g., 255). It will be appreciated that any consistently-used convention for designating task priorities could be used, e.g., zero could be the highest priority or the lowest priority, although for clarity in this description it is assumed that lower numbers imply lower priorities.

The example task control block 901 may also include a task state variable 904. It will be appreciated that the task state variable 904 may be an aggregation of different state bits for a task. Task states in the example embodiment may include “ready”, i.e., ready to execute. Task states in the example embodiment may also include “wait”, i.e., waiting for a semaphore or other resource indefinitely, without a timeout interval specified. Task states in the example embodiment may also include “wait+delayed”, i.e., waiting for a semaphore or other resource, with a timeout time interval specified. Task states in the example embodiment may also include “ready+delayed”, i.e., the task has received a resource for which it was waiting and is therefore no longer waiting, but the task's timeout timer has not yet been reset. This state may be used for tasks that have received a semaphore but have not yet executed since receiving the semaphore. Because such tasks may have their semaphore stolen, the timeout time interval is maintained on the system timeout queue until the task executes. It will be appreciated that other task states may be included.

The example task control block 901 may also include a blocking semaphore variable 906 that identifies a semaphore which has caused the corresponding task to block. This variable may be a pointer to the semaphore control data structure for the semaphore. It will be appreciated that other mechanisms for uniquely identifying the semaphore may be used, e.g., an identification number. Initially, the variable 906 may be set to a “NULL” value, assuming a newly created task is not blocked.

The example task control block 901 may also include a memory pointer 908 that may identify the portion of user memory that has been allocated to the task. It will be appreciated that additional memory pointers may be employed, e.g., to identify separate code and data portions of memory allocated to the task.

The example task control block 901 may also include a ready/wait queue pointer 910 and a ready/wait queue back pointer 912. These pointers may be used to form the linked list of task control blocks that may constitute the system ready queue and semaphore wait queues. These two pointers may be used identify preceding task and following task that come before and after the corresponding task in the queue which contains the corresponding task. The head and end of a queue may be denoted with special link symbols, e.g., “HEAD” and “NULL”.

The example task control block 901 may also include timeout queue pointer 914 and timeout queue back pointer 916. These pointers may be used to form the linked list of task control blocks that may be used to form the system timeout queue. The head and end of a queue may be denoted with special link symbols, e.g., “HEAD” and “NULL”.

The example task control block 901 may also include a timeout limit 918. This timeout limit may indicate a time until which the corresponding task will wait to receive the semaphore which the task has blocked on. Any consistently-used conventional representation for time may be used. For example, in the example embodiment, the timeout limit may designates a real time value represented with a pair of long integers representing the number of tics since a base time.

It will be appreciated that many other variables may be included in the task control block in support of other operating system functions. It will also be appreciated that different data structures may be used for individual task control blocks. It will also be appreciated that different data structures may be used to store all task control blocks in the system. For example, all task control blocks in a system may be stored in a table, as a linked list, or other conventional data structures.

Semaphore Control Data Structure

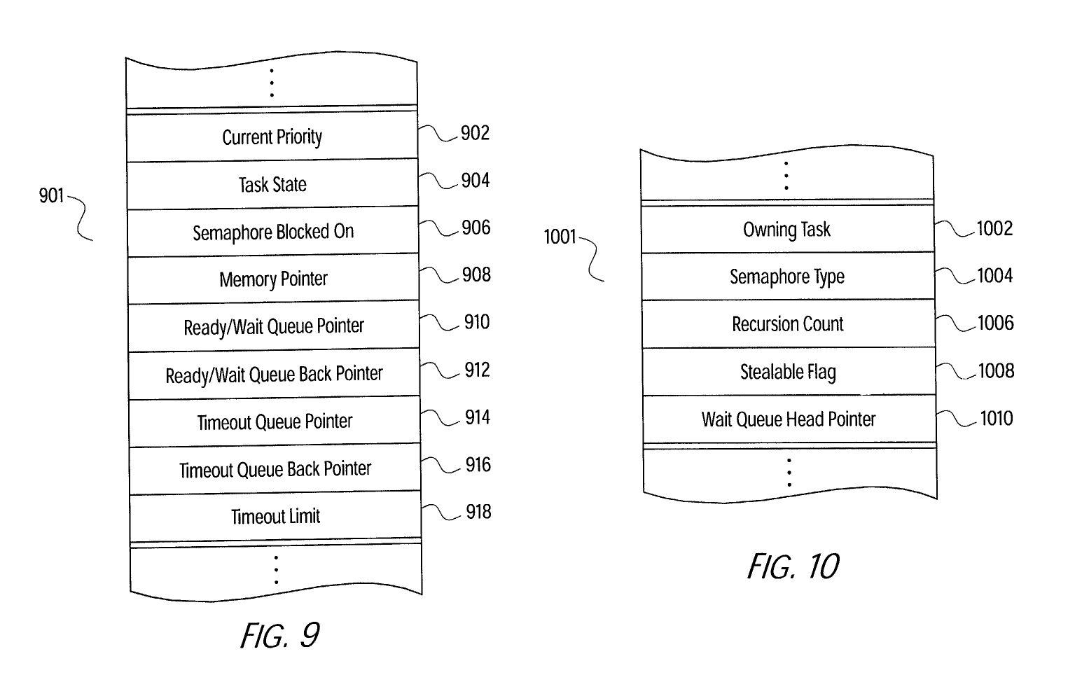

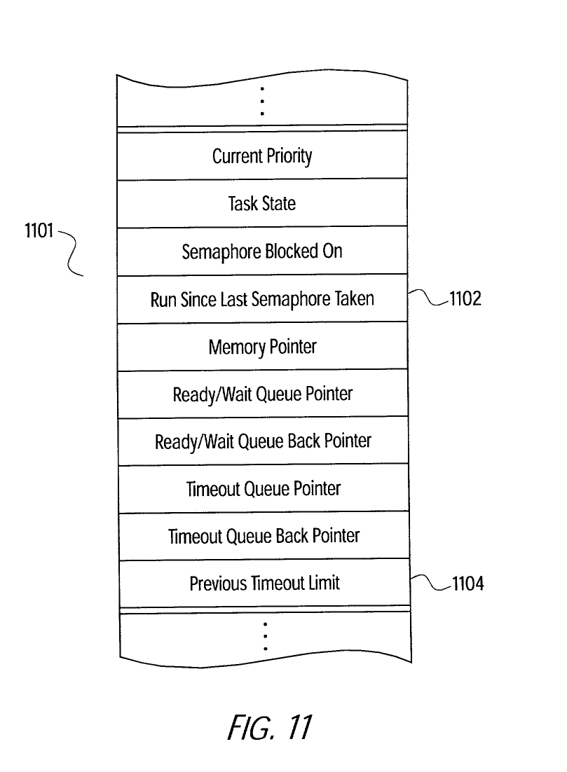

FIG. 10 illustrates an example semaphore control data structure 1001, in an example embodiment implemented according to the present invention. A semaphore control data structure may be included in a system for each semaphore in the system. The semaphore control data structure may be created when the corresponding semaphore is created.

It will be appreciated that any conventional data structure may be used for the semaphore control data structure. For example, in an object oriented system, a semaphore control data structure may be a memory object. All semaphore control data structures may be stored together in a table, linked list, or other conventional data structure. A semaphore control data structure may include one or more variables, as illustrated in FIG. 10.

An example semaphore control data structure 1001 may include an identifier 1002 which uniquely identifies the task currently owning or holding the semaphore. The identifier 1002 may be a pointer to the task control block for the corresponding task. It will be appreciated other conventional mechanisms for identifying the owning task may be used, e.g., a task identification number.

The example semaphore control data structure 1001 may include a field or variable 1004 indicative of the semaphore type. This field may indicate whether the semaphore is a binary semaphore, a mutual exclusion semaphore, or some other type of a semaphore. This field may also include one or more flags indicating various properties of the semaphore, e.g., a flag indicating whether the semaphore is inversion safe, whether the semaphore can be deleted, etc.

The example semaphore control data structure 1001 may include a recursion count 1006. The recursion count indicates the number of times the task currently holding the semaphore has recursively taken the semaphore. When a task first takes a semaphore, the recursion count may be set to zero.

The example semaphore control data structure 1001 may also include a “stealable flag” 1008, i.e., variable indicative of whether the semaphore can be stolen from the task that has currently holds the semaphore. This variable may be set to “TRUE” if the task holding the semaphore has not executed since receiving the semaphore, and “FALSE” otherwise. When the semaphore is given to a task while the giving task is running, the stealable flag is set to TRUE. When a task begins execution, the stealable flag is set to FALSE.

The example semaphore control data structure 1001 may also include a wait queue head pointer 1010. This pointer identifies the first entry in the linked list of entries corresponding to tasks waiting for the semaphore. The entries may be task control blocks of waiting tasks. The wait queue head pointer may be set to “NULL” when the semaphore's wait queue is empty. It will be appreciated that other conventional methods of maintaining a wait queue for the semaphore may be employed, e.g., the semaphore control data structure may include space to maintain a wait queue.

It will be appreciated that other fields or variables may be included as part of the example semaphore control data structure, e.g., a variable identifying a resource that is controlled by the semaphore.

### Alternative Example Embodiment

An alternative example embodiment may be provided according to the present invention. In the alternative example embodiment, the scheduler may be used to determine whether a semaphore has been stolen from a task when the task executes.

FIG. 11 illustrates an alternative example task control block data structure 1101, according to an alternative example embodiment of the present invention. The alternative example task control block data structure may include at least two fields that were not previously described. The alternative example task control block may include a variable associated with the task that indicates whether the task has run since receiving the semaphore, e.g., a “run since taken flag” 1102. The alternative example task control block may also include a “previous timeout” variable 1104.

When a semaphore is acquired by a task directly, i.e., the semaphore is not held by another task when it is requested, the “run since taken flag” may be set to “TRUE”, because the taking task is presently executing.

When a semaphore is received by the task during another task's execution, the run since taken flag 1102 flag may be set to FALSE, e.g., when the semaphore is acquired by the task during a give procedure executed by another task. Also, when a semaphore is received by the task during another task's execution, the previous timeout variable 1104 may be set to save a record of when the task's request for the semaphore that was just received would have timed out. The “blocked on semaphore” may be left undisturbed when a task receives a semaphore, allowing this field to be used determine what the last semaphore acquired by a task was. Alternatively, another field could be added to the alternative task control block to record the identity of the task's last acquired semaphore.

In the alternative example embodiment, a conventional task scheduler may be used with minor modifications. When a task is chosen by the scheduler to begin executing, the variable associated with the task that indicates that the task has not run since taking a semaphore may be set to indicate that the task has run. Similarly, any variable associated with semaphores held by the task that indicate that the task has not run since taking the corresponding semaphores must be set to indicate that the task has run since taking those semaphores. When the task is chosen by the scheduler to execute, the run since taken flag 1102 for the task may be set to “TRUE”. Setting the run since taken flag to TRUE will prevent a higher priority task from stealing the semaphore from the task. The “blocked on semaphore” or other variable recording the identity of the last acquired semaphore may also be cleared.

When a higher priority task attempts to steal a semaphore from task, the run since taken flag 1102 may be tested. If the flag is “TRUE”, the task has run since taking the semaphore, and the semaphore may not be stolen. However, if the flag is “FALSE” the semaphore sought by the higher priority task may be stealable, if it was the last semaphore taken by the task. If the last semaphore acquired by the task is the semaphore sought by the higher priority task, and the “run since taking flag” is FALSE, the semaphore may be stolen by the higher priority task. The last semaphore acquired may be determined by examining the blocked on semaphore variable, as described above. Additionally, when a semaphore is stolen from the task, the task's timeout clock may be reset, by using the previous timeout variable 1104.

### MODIFICATIONS

In the preceding specification, the present invention has been described with reference to specific example embodiments thereof It will, however, be evident that various modifications and changes may be made thereunto without departing from the broader spirit and scope of the present invention as set forth in the claims that follow. The specification and drawings are accordingly to be regarded in an illustrative rather than restrictive sense.

1. A method comprising:
assigning a resource to a holding task;
receiving a request by a higher priority task to take the resource, the higher priority task having higher priority than the holding task;
determining whether the holding task has used the resource since the resource was assigned to the holding task;
releasing the resource when the higher priority task requests to take the resource and the holding task has not used the resource since the resource was assigned to the holding task; and
assigning the resource to the higher priority task.

2. A method comprising:
assigning a semaphore to a holding task;
receiving a request by a higher priority task to take the semaphore, the higher priority task having higher priority than the holding task;
determining whether the holding task has executed since the semaphore was assigned to the holding task;
releasing the semaphore when the higher priority task requests to take the semaphore and the holding task has not executed since the semaphore was assigned to the holding task; and
assigning the semaphore to the higher priority task.

3. A method comprising:
assigning a semaphore to a holding task, the semaphore being a mutual exclusion semaphore;
receiving a request by a higher priority task to take the semaphore, the higher priority task having higher priority than the holding task;
determining whether the holding task has executed since the semaphore was assigned to the holding task;
releasing the semaphore held by the holding task when the higher priority task requests to take the semaphore and the holding task has not executed since the semaphore was assigned to the holding task; and
assigning the semaphore to the higher priority task.

4. The method according to claim 3, wherein
the step of determining whether the holding task has executed since the semaphore was assigned to the holding task includes testing a variable, the variable indicative of whether the holding task has executed since the semaphore was assigned to the holding task.

5. The method according to claim 4, wherein
the variable is associated with the holding task.

6. The method according to claim 4, wherein
the variable is associated with the semaphore.

7. The method according to claim 4, further comprising:
setting the variable, when the semaphore is assigned to the holding task, to indicate that the holding task has not executed since the semaphore was assigned to the holding task.

8. The method according to claim 3, further comprising:
assigning a second semaphore to a second holding task, the second semaphore being a mutual exclusion semaphore;
receiving a request by a second higher priority task to take the semaphore, the second higher priority task having higher priority than the second holding task;
determining whether the second holding task has executed since the second semaphore was assigned to the second holding task; and
maintaining control of the second semaphore by the second holding task when the second higher priority task attempts to take the second semaphore and the second holding task has executed since the second semaphore was assigned to the second holding task.

9. The method according to claim 8, wherein
the step of determining whether the second holding task has executed since the second semaphore was assigned to the second holding task includes testing a second variable, the second variable indicative of whether the second holding task has executed since receiving the second semaphore.

10. The method according to claim 9, further comprising:
setting the second variable to indicate that the second holding task has not executed when the second semaphore is assigned to the second holding task.

11. The method according to claim 9, further comprising:
setting the second variable to indicate that the second holding task has executed when the second holding task executes after receiving the second semaphore.

12. The method according to claim 9, wherein
the second variable is associated with the second holding task.

13. The method according to claim 9, wherein,
the second variable is associated with the second semaphore.

14. The method of claim 3, further comprising:
timing out a last request for the semaphore by the holding task if the last request would have already timed out had the holding task not received the semaphore by the time the semaphore is released.

15. The method of claim 3, further comprising:
adding an entry for the holding task to a wait queue.

16. A method comprising:
assigning a semaphore to a holding task, the semaphore being a mutual exclusion semaphore;
setting a variable to indicate that the holding task has not executed since receiving the semaphore when the holding task receives the semaphore, the variable indicative of whether the holding task has executed since receiving the semaphore;
receiving a request for the semaphore from a higher priority task, the higher priority task having higher priority than the holding task;
determining whether the holding task has executed since receiving the semaphore by testing the variable;
releasing the semaphore held by the holding task when the higher priority task attempts to take the semaphore and the holding task has not executed since receiving the semaphore;
timing out a last request for the semaphore by the holding task if the last request would have timed out had the holding task not received the semaphore by the time the holding task releases the semaphore;
assigning the semaphore to the higher priority task;
assigning a second semaphore to a second holding task, the second semaphore being a mutual exclusion semaphore;
setting a second variable to indicate that the second holding task has not executed since receiving the second semaphore when the second holding task receives the second semaphore, the second variable indicative of whether the second holding task has executed since receiving the second semaphore;
setting the second variable to indicate the second holding task has executed since receiving the second semaphore, when the second holding task first executes after receiving the second semaphore;
receiving a request for the second semaphore from a second higher priority task, the second higher priority task having higher priority than the second holding task;
determining whether the second holding task has executed since receiving the second semaphore by testing the second variable; and
maintaining control of the second semaphore by the second holding task when a second higher priority task attempts to take the semaphore and the second holding task has executed since receiving the second semaphore.

17. An article of manufacture comprising a computer-readable medium having stored thereon instructions adapted to be executed by a processor, the instructions which, when executed, define a series of steps to be used to control a method for resource control, said steps comprising:
assigning a semaphore to a holding task, the semaphore being a mutual exclusion semaphore;
receiving a request by a higher priority task to take the semaphore, the higher priority task having higher priority than the holding task;
determining whether the holding task has executed since the semaphore was assigned to the holding task;
releasing the semaphore held by the holding task when the higher priority task requests to take the semaphore and the holding task has not executed since the semaphore was assigned to the holding task; and
assigning the semaphore to the higher priority task.

18. An article of manufacture comprising a computer-readable medium having stored thereon instructions adapted to be executed by a processor, the instructions which, when executed, define a series of steps to be used to control a method for resource control, said steps comprising:
assigning a semaphore to a holding task, the semaphore being a mutual exclusion semaphore;
setting a variable to indicate that the holding task has not executed since receiving the semaphore when the holding task receives the semaphore, the variable indicative of whether the holding task has executed since receiving the semaphore;
receiving a request for the semaphore from a higher priority task, the higher priority task having higher priority than the holding task;
determining whether the holding task has executed since receiving the semaphore by testing the variable;
releasing the semaphore held by the holding task when the higher priority task attempts to take the semaphore and the holding task has not executed since receiving the semaphore;
timing out a last request for the semaphore by the holding task if the last request would have timed out had the holding task not received the semaphore by the time the holding task releases the semaphore;
assigning the semaphore to the higher priority task;
assigning a second semaphore to a second holding task, the second semaphore being a mutual exclusion semaphore;
setting a second variable to indicate that the second holding task has not executed since receiving the second semaphore when the second holding task receives the second semaphore, the second variable indicative of whether the second holding task has executed since receiving the second semaphore;
setting the second variable to indicate the second holding task has executed since receiving the second semaphore, when the second holding task first executes after receiving the second semaphore;
receiving a request for the second semaphore from a second higher priority task, the second higher priority task having higher priority than the second holding task;
determining whether the second holding task has executed since receiving the second semaphore by testing the second variable; and
maintaining control of the second semaphore by the second holding task when a second higher priority task attempts to take the semaphore and the second holding task has executed since receiving the second semaphore.

19. A system, comprising:
a semaphore; and
a semaphore control mechanism configured to release the semaphore if
(a) a first task holds the semaphore,
(b) a second task having a higher priority than the first task attempts to take the semaphore, and,
(c) when the second task attempts to take the semaphore, the first task has not executed since receiving the semaphore.

20. A system, comprising:
a semaphore, the semaphore being a mutual exclusion semaphore; and
a semaphore control mechanism, the semaphore control mechanism configured to release the semaphore if
(a) a first task holds the semaphore,
(b) a second task having higher priority than the first task attempts to take the semaphore, and,
(c) when the second task attempts to take the semaphore, the first task has not executed since receiving the semaphore.

21. The system according to claim 20, wherein
the semaphore control mechanism is configured not to release the semaphore when the second task attempts to take the semaphore and the first task has executed since receiving the semaphore.

22. The system according to claim 20, further comprising:
a variable indicative of whether the first task has executed since receiving the semaphore.

23. The system according to claim 22, wherein
the variable is associated with the semaphore.

24. The system according to claim 22, wherein
the variable is associated with the first task.

25. The system according to 20, further comprising:
a timeout mechanism, the timeout mechanism configured to time out a last request by the first task for the semaphore if
the second task attempts to take the semaphore and the first task has not executed since receiving the semaphore and
the last request would have timed out had the first task not received the semaphore by the time the semaphore is released.

26. A system, comprising:
a semaphore, the semaphore being a mutual exclusion semaphore;
a first task, the first task holding the semaphore;
a second task, the second task having higher priority than the first task;
a variable indicative of whether the first task has executed since receiving the semaphore, the variable associated with the first task;
a semaphore control mechanism configured
to release the semaphore when the second task attempts to take the semaphore and the first task has not executed since receiving the semaphore and
not to release the semaphore when the second task attempts to take the semaphore and the first task has executed since receiving the semaphore; and
a timeout mechanism, the timeout mechanism configured to time out a last request by the first task for the semaphore if the second task attempts to take the semaphore and the first task has not executed since receiving the semaphore and the last request by the first task for the semaphore would have timed out had the first task not received the semaphore by the time the semaphore is released.

27. A semaphore control block associated with a semaphore, the semaphore control block comprising:
a holding task identification variable, the holding task identification variable configured to indicate a task that presently holds the semaphore with which the semaphore control block is associated;
a stealable variable, the stealable variable configured to indicate whether the semaphore can be stolen from the task that presently holds the semaphore with which the semaphore control block is associated.

28. The semaphore control block associated with a semaphore according to claim 27, wherein
the stealable variable is a one-bit flag.
